(19) United States
(12) Patent Application Publication
(10) Pub. No.: US 2004/0058130 A1
(43) Pub. Date: Mar. 25, 2004

(54) Printed substrate with variable local attributes

(76) Inventor: Nicholas James Nissing, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 10/657,320

(22) Filed: Sep. 8, 2003

Related U.S. Application Data
(63) Continuation of application No. 09/929,132, filed on Aug. 14, 2001.

(51) Int. Cl. B32B 3/00

(52) U.S. Cl. 428/156; 428/195.1

(57) ABSTRACT

A printed substrate exhibiting local variation in color density of a given color within one or more printed areas of the substrate. The printed substrate comprises a substrate color density, a background color density, and a print element color density. The background color density is greater than the substrate color density.

### CROSS REFERENCES TO RELATED APPLICATIONS

This is a continuation application of U.S. patent application Ser. No. 09/929,132 filed Aug. 14, 2001, which claims the benefit of U.S. application Ser. No. 09/638,237 filed on Aug. 14, 2000.

### TECHNICAL FIELD

This invention relates to a printed substrate which exhibits local variations in color density of a given color within one or more printed areas of the substrate.

### BACKGROUND OF THE INVENTION

Applying images to substrates by utilizing pigment or dye based ink compositions is well known in the art. These images are generally applied for the purpose of making the article more aesthetically pleasing to the consumer.

One of the difficulties historically experienced with printed substrates (for example absorbent disposable paper products such as facial tissue, bath tissue, table napkins, wipes, diapers, woven disposable fabrics, nonwovens, wovens, cotton pads, and the like) that are printed with pigment based ink compositions is the tendency for the ink to rub-off of the surface of the paper upon exposure of the paper to liquids. The problem is even more pronounced for those absorbent disposable paper products printed with inks exhibiting relatively high color densities.

The tendency for the ink to rub-off of the printed paper product increases as the printed paper is exposed to liquids such as tap water. Furthermore, exposing the printed paper to common household cleaning products containing solventized alkaline liquids, or acid-containing cleaning liquids tends to increase ink rub-off as compared to exposure of the paper to tap water alone.

Commonly assigned U.S. Pat. No. 6,096,412 issued to McFarland et al. on Aug. 1, 2000, teaches an absorbent disposable paper product printed with inks which exhibit resistance to rub-off.

One of the drawbacks associated with using rub resistant inks relates to printing press hygiene. Inks that adhere well to the substrate often exhibit similar properties when in contact with the printing press. In particular, the print plates tend to accumulate ink deposits that can eventually lead to print defects in the printed substrate. In order to prevent print defects more frequent cleaning of the printing press is necessitated. This can lead to reduced printing process efficiency and increased cost associated with the installation and maintenance of printing press cleaning equipment.

Another drawback relates to the cost of the ink. The ink cost represents a substantial raw material cost in relation to the production of the printed paper products. A significant portion of the cost of the ink is due to the pigment concentration of the ink. For example, in order to produce printed paper products which exhibit high color density print images, a high concentration of ink pigment is required (i.e.; the color density of the print image is proportional to the concentration of ink pigment utilized to print the image). Therefore, all else being equal, a higher concentration of ink pigment yields a higher print color density, but at a higher cost. The cost becomes an especially relevant factor when printing on highly absorbent paper products.

Yet further, when printing halftone dots with ink, one way to vary color density is by varying the size of the halftone dots. During the printing process, as the halftone dot is applied to the substrate with the ink, an increase in halftone dot diameter on the substrate is typically observed. This is a result of the wet ink spreading on the substrate. This increase in halftone dot diameter is referred to as dot gain.

Dot gain is one factor which impacts the color density of the printed substrate's image area. Historically, dot gain has been viewed as a drawback of halftone dot printing as it tends to degrade the fine detail within the image area. Furthermore, dot gain does not provide variable color density in a given printed area. Because of these drawbacks, efforts have been made through the years to devise printing techniques which minimize dot gain.

It would be desirable to produce a printed substrate which exhibits print images having higher color densities without requiring the use of more concentrated ink compositions. It would also be desirable to produce printed substrates such as printed paper products without the need to use rub-resistant ink compositions. Furthermore, it would be desirable to vary color density in a given print region of the substrate by controlling the spreading of wet ink in this region.

The benefits of the present invention include the ability to produce printed substrates having higher color density print images in selective areas which exhibit resistance to ink rub-off while providing for a wider color pallet, and reduced ink consumption. Additionally, local variations in print attributes are controlled without requiring additional inks. Furthermore, this local variation of print attributes such as color density, and ink rub-off can be by selectively applied to portions of the printed area. This invention has broad applicability to a wide range of printing inks, substrates, and printing processes.

### SUMMARY OF THE INVENTION

This invention relates to a printed substrate exhibiting local variations in color density of a given color within one or more printed areas of the substrate. In accordance with the present invention, the local variations in color density within a printed area of the substrate are such that background color density is greater than that of substrate color density and less than that of print element color density.

Furthermore, the printed substrate of the present invention has at least one print region printed in accordance with the present invention. The printed substrate may also have one or more print regions printed in accordance with the prior art. For a printed substrate having at least one solid print region printed in accordance with the present invention and at least one solid print region printed in accordance with the prior art, the ratio of the color density of the region printed according to the present invention and the region printed according to the prior art is at least about 1.15, preferably at least about 1.20, and more preferably at least about 1.25.

For a printed substrate having at least one solid print region printed in accordance with the present invention and at least one solid print region printed in accordance with the prior art, the ratio of the dot area of the region printed according to the present invention and the region printed according to the prior art is at least about 1.10, preferably at least about 1.15, and more preferably at least about 1.25.

### BRIEF DESCRIPTION OF THE DRAWINGS

FIG. 1A is a plan view outline sketch of the details of the color photomicrograph of FIG. 1B.

FIG. 1B is a color photographmicrograph taken at 38× magnification of flexographically printed indicia having a prior art print region and a present invention print region.

FIG. 2A is a color photomicrograph taken at 38× magnification of prior art flexographically printed indicia.

FIG. 2B is a color photomicrograph taken at 38× magnification of present invention flexographically printed indicia.

FIG. 3 is a schematic side elevational view of a printing press suitable for use with the present invention.

### DETAILED DESCRIPTION OF THE INVENTION

In order to enhance the aesthetics of absorbent disposable paper products, it is desirable to use pigment-based inks which produce vibrant high color densities when applied to the absorbent disposable paper product. As used herein, “color density” may be defined by the following equation:

D=log₁₀I/R

wherein I, refers to the intensity of incident light, and R, refers to the intensity of reflected light.

Traditionally, when using a single color ink to print images comprised of individual print elements such as halftone dots, the macroscopic color density in a given region of the print image is adjusted by either varying the size or frequency of the individual print element.

When using a single color ink to print images comprised of individual print elements, the present invention allows the color density in a given print region to be varied without requiring a change in the size or frequency of the individual print element.

As used herein, “rub-off” refers to the transfer of color from the surface of a printed substrate to another surface. Rub-off is composed of two components, bleed and abrasion. Bleed refers to the tendency of color to leach out of a substrate upon exposure of the substrate to a liquid. Abrasion refers to the ability to remove ink from a substrate by mechanically scuffing the ink from the surface of the substrate.

As used herein, “halftone printing” refers to a method of printing which utilizes a plurality of dots to form the print image.

As used herein, “halftone image” refers to print images comprised of discrete dots.

As used herein, “print element” refers to the individual indicium which comprises the print image. A non-limiting example of a print element would be a halftone dot. A plurality of halftone dots comprise the print image.

As used herein, “image area”, “print region”, or “print area” are interchangeable terms which refer to the macroscopic region or area of the paper which exhibits the print image.

As used herein “microscopic region” refers to any region which is approximately the size of an individual print element.

As used herein “macroscopic region” refers to any region which can be resolved by the naked human eye at a distance of about 0.8 meters or greater.

As used herein, “solid print” refers to a printed area without discernable print elements. For example in the case of a flexographically printed substrate, a solid print is the printed area of the substrate which corresponds to the 100% raised surface on a flexographic printing plate. In the case of line printing, all of the printed regions are solids.

As used herein, “dot gain” refers to the expansion in the size of the individual halftone dot as it contacts the substrate. This increase in dot size is resultant from the spreading of the wet ink as it contacts the substrate.

As used herein, “dot area” refers to the area on the printed substrate which is covered with ink.

As used herein, “% dot coverage” refers to the amount of a specified print area covered by halftone dots in relation to the total specified print area.

As used herein “print element color density” refers to the color density of each individual print element within the image area of the printed substrate.

As used herein, “variable color density” refers to two or more different color densities found within the same area of the print image.

As used herein, “substrate color density”, refers to the color density of the unprinted areas of the substrate. A non-limiting example which illustrates this definition would be a paper product printed by the flexographic printing process. For a paper product printed by the flexographic printing process, substrate color density would refer to the areas of the printed paper product which do not comprise an image area (i.e.; the unprinted areas of the paper product).

As used herein “background color density” refers to the color density surrounding each individual print element within the image area of the printed substrate. For example, when printing images comprised of dots that are printed in accordance with the prior art, in a given image area, background color density is that of substrate color density. In contrast, when printing according to the present invention, background color density may be greater than that of substrate color density and less than that of print element color density.

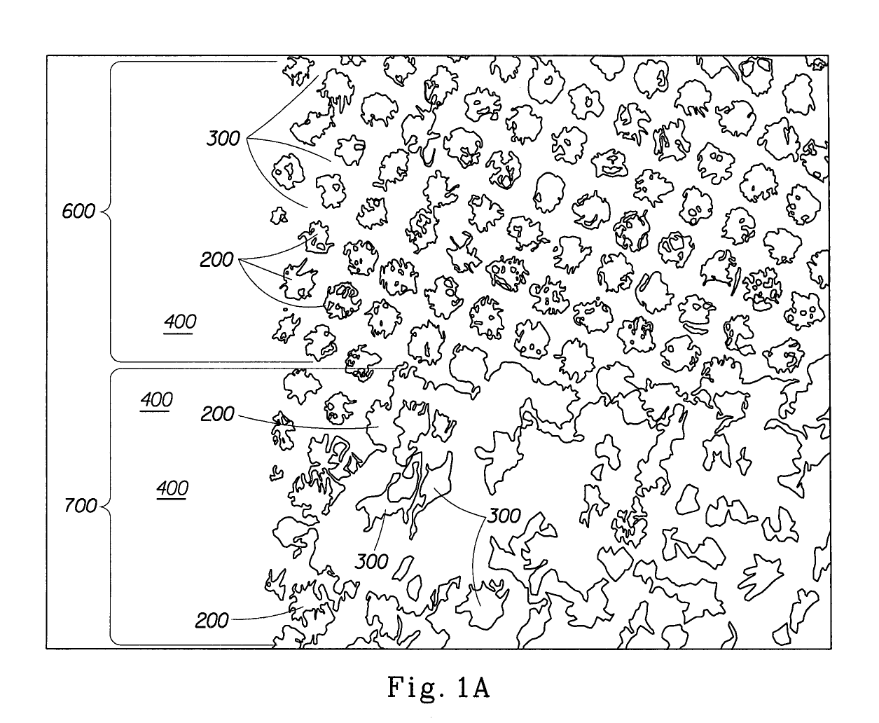

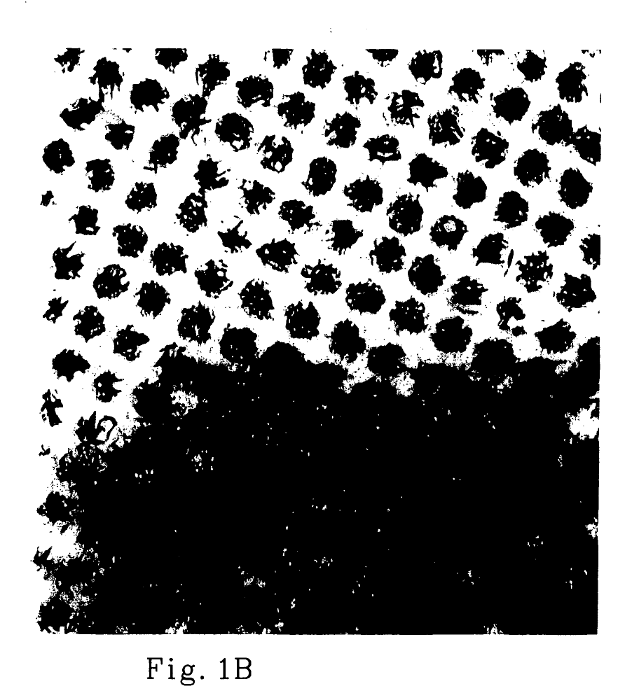

This is illustrated in FIG. 1. FIG. 1 is a color photomicrograph taken at a magnification of 38× depicting two distinct print regions (i.e.; a prior art print region 600 and a present invention print region 700). Referring to the prior art print region 600, the background color density 300 is the same as that of the substrate color density 400. Referring to the present invention print region 700, the background color density 300 is greater than that of the substrate color density 400 but less than that of the print element color density 200. In the case of a multi-color print, the background color density is defined as the color density of the area surrounding an individual print element within the image area which is not printed with additional colors other than that of the aforementioned print element.

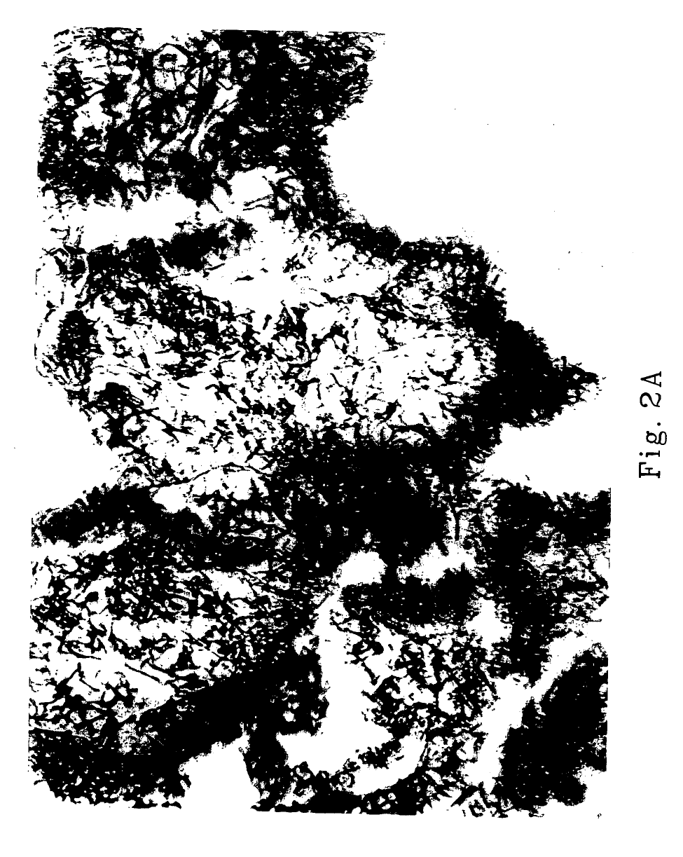

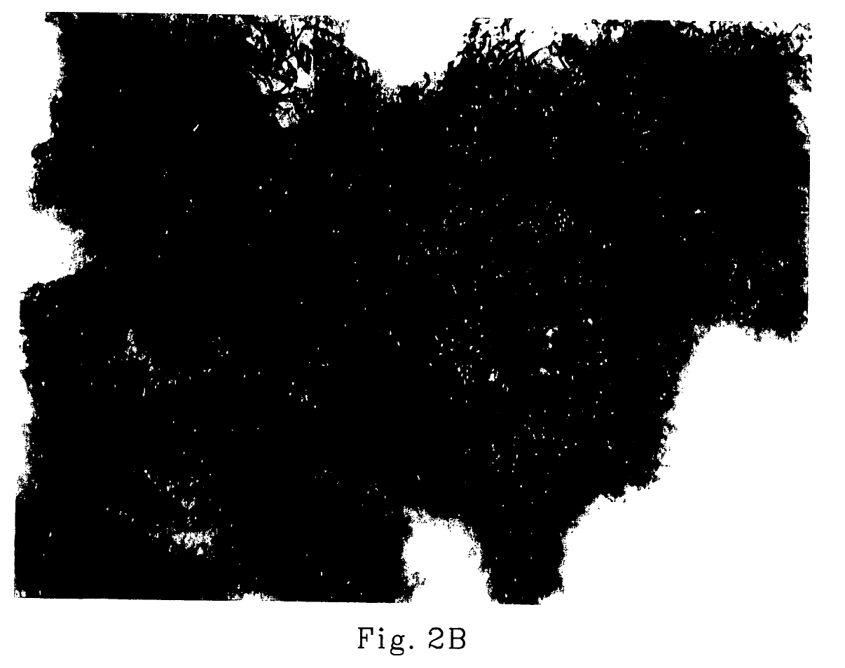

With regard to printing on textured substrates, it is more difficult to achieve uniform dot coverage in comparison to printing on untextured substrates. The present invention print image exhibits more uniform dot coverage when printing on textured substrates. This is illustrated in FIGS. 2A and 2B. FIGS. 2A and 2B are color photomicrographs taken at 38× magnification of multi-color flexographically printed substrates having the same dot coverage. Both FIGS. 2A and 2B represent the same textured substrate (i.e.; Bounty® brand paper towel commercially sold by the instant assignee). FIG. 2A represents a prior art print image while FIG. 2B represents a print image of the present invention.

Referring to the prior art print image of FIG. 2A, the nonuniform ink coverage is evident. Referring to the present invention print image of FIG. 2B, a much more uniform ink coverage is observed in comparison to FIG. 2A.

As used herein, “microscopic color density variation” refers to the gradual variation in the color density between a print element and the background surrounding the print element. This variation can be local in nature.

As used herein, “print enhancing fluid” refers to a fluid which is capable of enhancing the color density of a printed area of a printed substrate such as a paper product. One means of achieving microscopic color density variation is by utilizing a print enhancing fluid. Print enhancing fluids are disclosed in commonly assigned U.S. application Ser. No. 09/638,237 filed on Aug. 14, 2000, the disclosure of which is incorporated herein by reference.

As used herein, “local” refers to properties of a portion of the printed area found within the same printed substrate. For example, a portion of a printed area may have a different color density in one local region versus a second local region. Furthermore, as illustrated in FIG. 1, it is within the scope of this invention to have a printed substrate which may have one or more local regions printed according to the prior art 600 and one or more local regions printed in accordance with the present invention 700.

Images printed according to the present invention exhibit microscopic color density variation. The microscopic color density variation may be local in nature whereas some print regions exhibit this property and others may not. It should be noted, that substrates printed according to the present invention may include microscopic print regions which are traditionally printed (i.e.; where the background color density is equal to the substrate color density) as well as areas printed according to the present invention.

In order to adjust the macroscopic color density of a print image in a given print region, it has traditionally been required that adjustments be made to the size or frequency of the individual print element(s). To achieve this, these individual print element(s) are reduced in size or frequency such that the lighter background is visible to a larger extent between the print element(s).

While not wishing to be bound by theory, it is believed that this lighter background color lowers the perceived color density because the human eye averages between the color density of the print element(s) and the color density of the unprinted substrate.

However, in the case of the present invention, it is possible to vary the color density such that more than one color density exists in the same print region without requiring adjustments to the size or frequency of the individual print elements(s).

The present invention relates to a substrate having an ink composition applied thereon. The individual components of the ink composition may be applied to the substrate as a mixture or sequentially. A print enhancing fluid is applied to the substrate prior to ink application in order to enhance the color density of the image printed on the sheet.

Substrate

The present invention may be used in conjunction with any type of substrate which may be printed. The substrate may be textured or untextured. The substrate may include materials which are cellulosic, noncellulosic, or a combination thereof. Examples of such substrates include but are not limited to textiles (e.g.; woven and non woven fabrics and the like) and preferably absorbent disposable paper products. Non-limiting examples of absorbent disposable paper products include toweling, facial tissue, bath tissue, table napkins, plates, wipes, diapers, incontinence garments, cotton pads, and the like.

Preferably the substrate is an absorbent disposable paper product, such as tissue, towel, or the like having a basis weight of between about 10 g/m² to 130 g/m², preferably between about 20 g/m² to 80 g/m², and most preferably between about 25 g/m² to 60 g/m². The substrate of this invention has a first surface and a second surface wherein the second surface is oppositely disposed to the first surface. A print enhancing fluid may be applied to the surface(s) which is to be printed. Ink is applied to at least one of the first and second surfaces.

The substrate of this invention may be made according to commonly assigned U.S. Pat. Nos. 4,191,609 issued Mar. 4, 1980 to Trokhan; 4,300,981 issued to Carstens on Nov. 17, 1981; 4,514,345 issued to Johnson et al. on Apr. 30, 1985; 4,528,239 issued to Trokhan on Jul. 9, 1985; 4,529,480 issued to Trokhan on Jul. 16, 1985; 4,637,859 issued to Trokhan on Jan. 20, 1987; 5,245,025 issued to Trokhan et al. on Sep. 14, 1993; 5,275,700 issued to Trokhan on Jan. 4, 1994; 5,328,565 issued to Rasch et al. on Jul. 12, 1994; 5,334,289 issued to Trokhan et al. on Aug. 2, 1994; 5,364,504 issued to Smurkoski et al. on Nov. 15, 1995; 5,527,428 issued to Trokhan et al. on Jun. 18, 1996; 5,556,509 issued to Trokhan et al. on Sep. 17, 1996; 5,628,876 issued to Ayers et al. on May 13, 1997; 5,629,052 issued to Trokhan et al. on May 13, 1997; and 5,637,194 issued to Ampulski et al. on Jun. 10, 1997, the disclosures of which are incorporated herein by reference for the purpose of showing how to make a substrate suitable for use with the present invention.

The substrate may also be made according to U.S. Pat. No. 5,411,636 issued to Hermans et al. on May 2, 1995 and EP 677612 published in the name of Wendt et al. on Oct. 18, 1995.

The substrate of the present invention may be through air dried or conventionally dried. Optionally, it may be foreshortened by creping or by wet microcontraction. Creping and/or wet microcontraction are disclosed in commonly assigned U.S. Pat. Nos. 6,048,938 issued to Neal et al. on Apr. 11, 2000; 5,942,085 issued to Neal et al. on Aug. 24, 1999; 5,865,950 issued to Vinson et al. on Feb. 2, 1999; 4,440,597 issued to Wells et al. on Apr. 3, 1984; 4,919,756 issued to Sawdai on Apr. 24, 1990; and U.S. Pat. No. 6,187,138 issued to Neal et al. on Feb. 13, 2001, the disclosures of which are incorporated herein by reference.

With regard to printing images on textured substrates, the printing plate may produce a nonuniform print image due to irregularities on the surface of the substrate which remain unprinted. For example, papers which are embossed or have significant texture imparted by the drying fabric of the paper machine often create regions which cannot adequately covered with ink by prior art printing processes. This is illustrated by the prior art print image of FIG. 2A. The prior art print image of FIG. 2A is printed on a textured substrate. Those surfaces of the textured substrate which protrude the furthest out of the plane in the Z direction of the substrate are most likely to be completely covered with ink. Conversely, depressions in the surface of the substrate such as embossments or even gaps between the uppermost layers of fibers often create areas with no ink coverage within the image area.

In contrast, textured printed substrates of the present invention exhibit significantly fewer areas and in some cases no print areas without ink coverage. This is illustrated by the present invention print image of FIG. 2B. The resulting printed substrate image area(s) has a much more continuous appearance. Therefore, this invention may have particular application to substrates with relatively high texture (including but not limited to substrates such as absorbent disposable paper products).

Ink

The ink composition which may be used with the present invention is any liquid composition which may be applied onto the substrate in a predetermined pattern.

Components of the ink composition may include but are not limited to: a vehicle such as a solvent or water; a colorant such as a pigment or dye; a binder; and other components which may include but are not limited to wax, crosslinking agents, fixatives, pH control agents, viscosity modifiers, defoamers, dispersants, printing press hygiene control agents, preservatives, and corrosion control agents.

As used herein, “ink” refers to any composition or components thereof applied to the substrate and which remains thereon in a visible pattern even though components of the ink may evaporate. The components of the ink composition may be applied to the substrate sequentially or as a mixture. A “predetermined pattern” or “image” or “indicia” refers to any desired array or application of ink onto the substrate and is inclusive of all combinations of patterns ranging from small individual dots to complete coverage of the entire surface of the substrate.

As used herein, “vehicle” refers to the liquid component of the ink composition utilized to convey the ink composition to the surface of the substrate. As used herein, “pigment” refers to insoluble color matter used in finely divided dispersed form to impart color to the ink. As used herein, “dye” refers to a colorant soluble in the continuous phase of the ink. As used herein, “binder” refers to the adhesive component of the ink composition.

Suitable ink compositions include but are not limited to those ink compositions that are in the form of a liquid at room temperature (i.e.; a temperature of about 20° C.). The ink compositions will preferably utilize water as a vehicle and pigment as a colorant.

A binder is generally needed for the ink to adhere to the surface of the substrate. In general, rub-off resistance of the ink composition increases as adherence of the ink to the surface of the substrate increases. Ink compositions which include binders comprised of film-forming polymers tend to have improved adherence of the ink to the surface of the substrate in comparison to inks containing non film-forming binders.

A non-limiting list of optional additives which may be added to the finished ink compositions or a print enhancing fluid include crosslinking agents, printing press hygiene control agents, humectants, corrosion control agents, pH control agents, viscosity modifiers, preservatives, and defoamers.

Crosslinking agents are generally added to the finished ink composition or to a pigment dispersion. As used herein, “finished ink composition” refers to an ink composition that contains the key components such as a vehicle, pigment, and binder so as to render the ink composition ready to use. As used herein, “pigment dispersion” refers to a composition comprised of pigment solids, surfactant, and a vehicle such as water or oil to which a binder is added.

Crosslinking agents are believed to enhance the rub-off resistance of the ink by crosslinking with the ink. Glycerin or other humectants may also be added to the ink composition in order to improve ink rub-off resistance, press hygiene, process efficiency, or process reliability.

Methods of curing inks include but are not limited to thermally curing, electron beam curing, photon curing (for example ultraviolet light, x-ray, and gamma ray), and combinations thereof.

There are numerous printing processes which can be used to deposit ink onto a substrate. A non-limiting list of these printing processes include flexography, direct gravure, offset gravure, lithography, letterpress, intaglio, and ink jet. It is desirable that the process by which these inks are deposited on the substrate deliver consistent product over long periods of time. Ink or fiber deposits on the printing apparatus can require manual intervention to remove. Significant manual intervention causes unacceptable costs to be associated with the process. Therefore, it is desirable to limit the amount of manual intervention needed to print reliably and consistently.

In particular, inks which include binders that are highly rub resistant tend to cause more print defects due to buildup on the printing plates. This becomes especially problematic when using a flexographic printing process. Therefore, it is desirable to minimize the use of these highly rub resistant binders while still maintaining low ink rub-off. Additionally, it has been found that printed paper products which exhibit higher color densities tend to have higher levels of ink rub-off, all else being equal.

The present invention provides a printed substrate which exhibits higher color densities while still maintaining low ink rub-off. This is possible because ink is more efficiently dispersed on the surface of the substrate. This more efficient ink dispersion can be accomplished without degrading the macroscopic appearance of the print image. The net result is a lower ink rub-off at a given color density for the same ink and same substrate versus the prior art.

Print Enhancing Fluid

One means of achieving the printed substrate of the present invention is by utilizing a print enhancing fluid as disclosed in U.S. Ser. No. 09/638,237 filed Aug. 14, 2001, the disclosure of which is incorporated herein by reference. The print enhancing fluid provides for a more efficient dispersion of the ink onto the surface of the paper product. While not wishing to be bound by theory, the print enhancing fluid may increase the mobility of the ink thereby creating a more efficient distribution of the ink on the surface. The net result is an aesthetic improvement in the print image obtained via an increase in color density without increasing ink consumption or ink rub-off. Furthermore, this aesthetic improvement is also achieved without requiring a change in size or frequency of individual print elements.

Moreover, in accordance with the present invention, this aesthetic improvement results in a printed substrate which exhibits local variations in color density within one or more printed areas of the substrate. These local variations in color density within a printed area of the substrate are exemplified by a background color density that is greater than that of substrate color density and less than that of print element color density.

Suitable liquids which may be utilized as print enhancing fluid include polar and nonpolar fluids. The print enhancing fluid can be hydrophilic or hydrophobic. The print enhancing fluid can be in the form of a solution or emulsion. The print enhancing fluid can be used in conjunction with any type of ink including but not limited to oil based inks, solvent based inks, and preferably water based inks. Furthermore, it can be used in conjunction with dye based inks and preferably pigment based inks. While not wishing to be bound by theory, it is believed that any fluid which is miscible with the ink is suitable as a print enhancing fluid.

Non-limiting examples of suitable print enhancing fluids include those disclosed in U.S. Ser. No. 09/638,237 filed on Aug. 14, 2000 the disclosure of which is incorporated herein by reference. These include but are not limited to water, oil, alcohol, and mixtures thereof, preferably water, alcohol, or an alcohol-water mixture, and most preferably water.

Optional additives may be added to the print enhancing fluid. A non-limiting list of optional additives which may be added include crosslinking agents, printing press hygiene control agents, surfactants, fixatives, humectants, corrosion control agents, pH control agents, viscosity modifiers, preservatives, odor control agents, binders, colorants, and/or defoamers. If added, optional additives comprise less than about 50% of the print enhancing fluid by weight, preferably less than about 25% of the print enhancing fluid by weight, and most preferably less than about 5% of the print enhancing fluid by weight. These optional additives may be added to the print enhancing fluid so long as the resultant mixture is miscible with the ink and fluid enough that the pigment particles are mobile in the fluid.

Applying Ink and the Print Enhancing Fluid to the Substrate

The print enhancing fluid is applied to the substrate prior to the ink. The print enhancing fluid may be applied directly or indirectly to the substrate.

The print enhancing fluid is applied to the substrate in an amount of from about 1 g/m² to 50 g/m², preferably from about 5 g/m² to 30 g/m², and most preferably from about 10 g/m² to 20 g/m².

The print enhancing fluid can be used in conjunction with any type of printing application including but not limited to ink jet, rotogravure, letterpress, intaglio, lithography, silk screen, and preferably flexography. When using a print enhancing fluid on a multi-color printing press, the fluid may be applied if desired prior to one or more of the print stations.

If desired the print enhancing fluid may be applied in registration with the print image. As used herein, “registration” refers to aligning the application of the print enhancing fluid with the application of ink.

While not wishing to be bound by theory, it is believed that the amount of print enhancing fluid required may depend on the absorbency of the substrate. That is, a substrate with a relatively high absorbency may require more print enhancing fluid than a sheet with a relatively low absorbency.

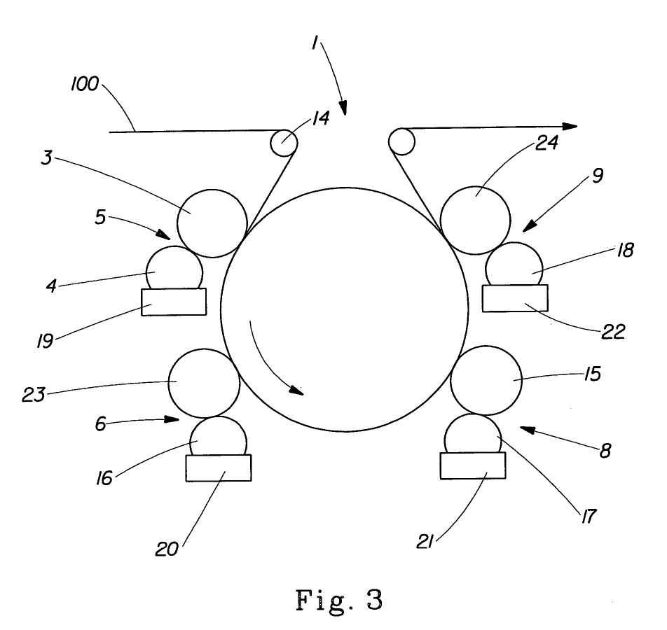

Referring to FIG. 3, a multicolor printing press 1 useful for producing the printed substrate of the present invention is shown. Printing press 1 has four print stations. A print enhancing fluid may be applied prior to first print station 5. Alternatively, if desired a print enhancing fluid may be added to each of first print station 5, second print station 6, third print station 8, and fourth print station 9.

Furthermore, if variable color density is desired for only one particular color a print enhancing fluid may be added just before that particular print station. For multicolor printing in some instances it may be desirable to apply a print enhancing fluid between print stations such that the indicia applied to the substrate 100 at the immediately preceding print station does not exhibit variable color density but any indicia applied to the substrate 100 after the application of the print enhancing fluid does exhibit variable color density.

Any combination of addition points obvious to those of ordinary skill in the art may be used so long as the print enhancing fluid is added prior to the ink.

For example, referring to the printing press 1 of FIG. 3, if variable color density is only desired for substrate 100 image area produced by the ink of the third print station 8, the print enhancing fluid would have to be applied to substrate 100 after second print station 6 but before third print station 8 plate cylinder 15.

Alternatively, or in addition to, a print enhancing fluid may be applied directly to one or more of first print station 5 anilox roll 4, second print station 6 anilox roll 16, third print station 8 anilox roll 17, or fourth print station 9 anilox roll 18. The print enhancing fluid can be sprayed onto the anilox roll 4. Alternatively, or in addition to, print enhancing fluid may be applied to one or more of first print station 5 print fluid pan 19, second print station 6 print fluid pan 20, third print station 8 print fluid pan 21, or fourth print station 9 print fluid pan 22.

Alternatively, or in addition to, a print enhancing fluid may be applied directly (for instance by spraying) to one or more of first print station 5 plate cylinder 3, second print station 6 plate cylinder 23, third print station 8 plate cylinder 15, or fourth print station 9 plate cylinder 24.

All of the above are intended to be non-limiting examples of print enhancing fluid application points. These are for illustrative purposes and are not intended to limit the scope of the invention. Other application points and other application methods familiar to those of ordinary skill in the art may also be utilized and are intended to be covered within the scope of the present invention.

Ink may be applied to the substrate directly or indirectly in any number ways including but not limited to: dipping the substrate into a solution of ink, spraying a solution of ink onto the substrate, or preferably by printing the ink onto the substrate. The print enhancing fluid may be applied to the paper in like manner.

Additionally, combinations of the various application methods may be used (i.e.; spraying a portion of the print enhancing fluid onto the substrate while printing the print enhancing fluid onto the substrate).

Printing processes suitable for this invention include but are not limited to: lithography, letterpress, ink jet printing, gravure, screen printing, intaglio and preferably flexography. Likewise, combinations and variations thereof are considered to be within the scope of the present invention. A single color image or multi-color image may be applied to the substrate. Devices suitable for applying an image onto a sanitary disposable paper in accordance with the present invention are described in commonly assigned U.S. Pat. Nos. 5,213,037 issued to Leopardi, II on May 25, 1993; 5,255,603 issued to Sonneville et al. issued on Oct. 26, 1993; and 6,096,412 issued to McFarland et al. on Aug. 1, 2000, the disclosures of which are incorporated herein by reference.

The printed image produced on the substrate can be line work, halftoning, preferably a process print, or a combination of these. As used herein, “process print” refers to a halftone color print created by the color separation process whereby an image composed of two or more transparent inks is broken down into halftone dots which can be recombined to produce the complete range of colors of the original image.

Coloration in a process print image is produced by varying the amount of ink deposited in a given image area and by overlaying different color inks in order to produce the desired color(s) in the image area (i.e.; for example applying cyan ink over magenta ink, etc.). The ink deposition area may be varied by adjusting the frequency, size, or combination thereof of halftone dots.

An image is process printed, if the image is printed with two or more colors. Furthermore, the inks may produce a multitude of colors when the inks are overlayed. The advantage of a process printed image over a line work printed image is that the process printed image enables many colors and shades of those colors to be produced with a few inks.

For example, a full color image may be comprised of ten or more colors. This image can be reproduced by process printing utilizing as few as three colors. The same image reproduced by line work would typically require ten or more inks each with a corresponding printing station on the printing press. A printed image produced by line work often increases both the cost and the complexity of reproducing the image. Though the preferred ink compositions of the present invention are pigment-based process inks, other types of pigment-based and dye-based inks are within the scope of this invention.

As used herein, “transparent ink” refers to an ink which has minimal hiding power thus allowing some of the light to pass through it. With a transparent ink, light must be able to penetrate one or more ink layers while only certain wavelengths are absorbed. To make a red, for example, yellow is printed over magenta. Yellow absorbs blue wavelengths allowing red and green wavelengths to pass through. Magenta absorbs green wavelengths. The remaining wavelengths are reflected as red.

In contrast to transparent inks, when opaque inks (i.e.; non-transparent inks) are overlayed, the top color is the dominant color since it absorbs most light other than the specific wavelengths of its color. For example, an opaque yellow ink would absorb blue wavelengths while reflecting the red and green wavelengths to produce a yellow.

While the present invention may be used for any combination of single color, multicolor, or process printing, it is of particular use in process printing. While not wishing to be bound by theory, it is believed that each successive color will exhibit a response to a print enhancing fluid when process printing, unless the fluid is completely absorbed into the substrate or volatilized.

One of the benefits of the present invention is that a printed substrate can exhibit a wider color pallet thereby creating a more aesthetically pleasing product. As used herein, “color pallet” refers to the total range of colors which can be produced by a printing process.

Additionally, it has been found that registering the application of a print enhancing fluid with an ink can be advantageous to some processes. Registering the application of a print enhancing fluid with the application of ink allows for selective application of the print enhancing fluid to the substrate wherein some, but not all areas of the substrate may have print enhancing fluid applied thereon. This selective application reduces the consumption of the print enhancing fluid as well as provides for a wider array of print image qualities.

With regard to the present invention, a region of high percent dot coverage combined with the increased dot gain associated with the present invention will yield a printed substrate having a region(s) of higher color density than for a prior art printed substrate. However, a printed substrate in accordance with the present invention may also include prior art print regions having low percent dot coverage combined with low dot gain, thereby maintaining the ability to print low color densities. For example, a printed substrate in accordance with the present invention may exhibit print regions of increased color densities in those areas which utilize a print enhancing fluid while color density of the same printed substrate is not increased in those print areas which do not utilize a print enhancing fluid. Hence, by combining print areas with and without the print enhancing fluid, the net results will be a wider color pallet.

Color Density of a Printed Image

The color density of an image may be measured with a densitometer. Color density, a dimensionless measurement, refers to the density of the color produced by the ink. The higher the color density of the ink, the greater the intensity or strength of the color. As color density increases, the densitometer measurements also increase. The densitometer measures the color density of the dominant primary color present in the image. The densitometer then displays the color density of the dominant primary color. As used herein, “primary color” refers to one of the four colors of yellow, cyan, magenta, and black.

The color density of an image printed on a paper product may be measured as follows: Using a reflectance densitometer, the densitometer setting is adjusted so as to read the dominant primary color present in the image. The printed paper product sample is placed on top of four unprinted sheets. The four unprinted sheets are used in order to eliminate the influence of background color from a colored surface.

These four sheets of a white substrate having an L*a*b* value, of about 91.17, 0.64, and 4.29, respectively may be used wherein the L*a*b* value is measured by a spectrocolorimeter set to a 10° observer angle with illuminant A in the CIELAB L*a*b* mode. A white substrate having an L*a*b* value of about 91.17, 0.64, and 4.29 respectively is white BOUNTY® paper towel marketed by the instant assignee.

Three color density measurements are made within a given color of an image using the reflectance densitometer. The average of the three measurements is calculated and recorded.

Color density measurements may be measured on any ink that is applied to any color substrate. Preferably color density is measured on any substrate with a white background having an L*a*b* of about 91.17, 0.64, and 4.29, respectively. A suitable densitometer for measuring color density is the X-RITE 418 reflectance densitometer commercially available from X-Rite, Inc. of Grandville, Mich.

As used herein, “L*a*b*”, refers to the CIELAB L*a*b* color definition system. The CIELAB L*a*b* color definition system evaluates the color variation in a defined area of a sample and compares this variation to that of a standard reference. The colors are defined by a set of mathematical functions known as L*a*b* values, which describe the human eye's sensitivity to color. The L* relates to the lightness of the sample. The a* refers to the redness of the sample if the value of a* is positive. If the value of a* is negative, it refers to the greenness of the sample. The b* refers to the yellowness of the sample if the value of b* is positive. If the value of b* is negative, it refers to the blueness of the sample. From the L*a*b* values a ΔE value, a dimensionless measurement, can be determined wherein ΔE represents the difference in color between two different sets of L*a*b* values. The greater the ΔE, the greater the color difference.

### EXAMPLES

### Example 1

An embodiment of the present invention wherein the ink is applied to the substrate using a flexographic printing press and a print enhancing fluid is applied by spraying directly onto the substrate.

Commercially available BOUNTY® (white) paper towel marketed by the instant assignee was utilized for this example. A four color flexographic printing press as shown in FIG. 3 was used to print on the BOUNTY® paper towel. Four inks commercially available from Sun Chemical Corporation of Northlake, Ill. were used.

Referring to FIG. 3, a yellow ink (commercially available from Sun Chemical as No. 1696651) was added to first print station 5 print fluid pan 19. A magenta ink (commercially available from Sun Chemical as No. 1696652) was added to second print station 6 print fluid pan 20. A cyan ink (commercially available from Sun Chemical as No. 1696653) was added to third print station 8 print fluid pan 21. A black ink (commercially available from Sun Chemical as No. 1696654) was added to fourth print station 9 print fluid pan 22.

The plate cylinder squeeze settings and registration were adjusted using standard techniques known in the art. For comparison purposes a control substrate was printed according to the prior art.

Substrate 100 was then printed according to the present invention. A print enhancing fluid (water) was applied to substrate 100 prior to first print station 5. The water was applied using a high pressure-low volume spray gun, commercially sold as Binks Model 95, available from ITW Industrial Finishing of Glendale Heights, Ill. The water addition rate to substrate 100 was approximately 20 g/m².

The results are shown in Table I. Referring to Table I, the color density of the control towel and the towel printed according to the present invention was measured for each color printed. Color density was measured in accordance with the measurement procedures previously described in the instant specification. As can be seen, for each color printed, the color density of the towel printed according to the present invention is significantly higher than the towel printed according to the prior art.

TABLE I

| | Color Density | Color Density |
|---|---|---|
| | (Prior Art Control) | (Present Invention) |
| Yellow | 0.45 | 0.50 |
| Magenta | 0.59 | 0.73 |
| Cyan | 0.56 | 0.75 |
| Black | 0.49 | 0.64 |

### Example 2

An embodiment of the current invention wherein the ink is applied using a flexographic press and the print enhancing fluid is applied by flexographic printing.

Commercially available BOUNTY® (white) paper towel marketed by the instant assignee was utilized for this example. Two print stations (i.e.; first print station 5 and second print station 6) of a four color flexographic printing press 1 as shown in FIG. 3 was used to print on the BOUNTY® paper towel. A water based magenta ink sold as WKJFW2618915 commercially available from Sun Chemical Corporation of Northlake, Ill. was used for this purpose.

The print plates were photopolymer printing plates as are known in the art. The print plate on first print station 5 plate cylinder 3 utilized a 20% dot coverage area at a 65 linescreen. The second print station 6 plate cylinder 23 utilized 5%, 10%, 15%, 25%, 75%, and 100% dot coverage areas, all at a 65 linescreen.

The plate cylinder squeeze settings and registration were adjusted using standard techniques known in the art. For comparison purposes a control substrate was printed according to the prior art wherein magenta ink was applied at the second print station 6. No print enhancing fluid was applied to the control substrate.

Substrate 100 was then printed according to the present invention. Referring to FIG. 3, water was applied to the first print station 5 print fluid pan 19. It is estimated that approximately 11 g/m² of water was transferred from the first print station 5 printing plate to substrate 100.

The results are shown in Table 2. Referring to Table 2, the color density of the control towel and the towel printed according to the present invention was measured for each magenta % dot coverage area of the printed towel. Color density was measured in accordance with the measurement procedures previously described in the instant specification. As can be seen, for each % dot coverage area, the color density of the towel printed according to the present invention is significantly higher than the towel printed according to the prior art.

TABLE 2

| | Color Density | Color Density |
|---|---|---|
| % Dot | (Prior Art Control) | (Present Invention) |
| 5 | 0.28 | 0.38 |
| 10 | 0.30 | 0.45 |
| 15 | 0.35 | 0.55 |
| 25 | 0.45 | 0.69 |
| 50 | 0.63 | 0.84 |
| 75 | 0.68 | 0.89 |
| 100 | 0.72 | 0.87 |

Methods

Method 1: Method for Quantifying Rub-Off at a Constant Color Density:

This method is used in instances where a printed substrate exhibits both a print region printed according to the present invention and a print region printed according to the prior art and wherein both of these regions exhibit the same color density. The printed region in accordance with the present invention should typically have a lower ink rub-off than the prior art print region:

1. Select the two print regions of the printed substrate which are to be measured. Both regions should be printed with the same color and both regions should be of the same color density as one another. Color density measurements and ink rub-off measurements should be made in accordance with “Procedure for Measuring Color Density of a Printed Image” and “Procedure for Generating Ink Rub-off” respectively as disclosed in commonly assigned U.S. Pat. No. 6,096,412 issued to Mcfarland et al. on Aug. 1, 2000, the disclosure of which is incorporated herein by reference.

2. The rub-off ratio (i.e.; Rr) at constant color density is defined as the ratio between the print region having the higher rub-off value (i.e.; R1) and the print region having the lower rub-off value (i.e.; R2) wherein Rr=R1/R2.

With regard to the present invention, the rub-off ratio at constant color density (i.e.; Rr) is preferably greater than 1.1.

Method 2: Method for Quantifying Dot Area Ratio and Color Density Ratio of a Solid Region:

This effect can be measured by comparing the color density and dot area of solid regions. For example, assuming no changes to the substrate or the printing process, two solid print regions should have the same color density and dot area within normal variation. However, in the case of printed substrates of the present invention, higher color densities and greater dot area can be generated in areas of solid regions. The dot area of a printed region can be approximated using the Murray-Davies equation:

Dot area=(1−10^{Dm})/(1−10^{Ds})*100

wherein Dm is the color density of the measured region and Ds is the color density of a solid region.

1. Select two regions of solid print (i.e., print areas in which there are no discernible dots).

2. Measure the color density of each region using a reflectance densitometer such as an X-RITE 418 reflectance densitometer.

3. Measure the dot area of each region using the region with the higher color density to set the upper limit on dot area. For the sake of calibrating the dot area measurement, set the region with the higher color density to 100% on the densitometer (i.e.; utilize the higher color density region to define the 100% or “solid” benchmark). This insures that the ratios mentioned below are always greater than 1.

4. The ratio of color density is defined as Ir=I1/I2, wherein I1 is the color density of the print region with the highest color density and I2 is the color density of the print region with the lowest color density.

5. The ratio of dot area is defined as Dr=D1/D2, wherein D1 is the dot area of the higher color density region and D2 is the dot area of the lower color density region.

To illustrate this method, using the solid regions of a product made in accordance with Example 2 above, the solid region printed in accordance with the prior art had a reflectance densitometer color density reading of 72 and a dot area of 88%. The solid print region made in accordance with the present invention had a reflectance densitometer color density reading of 87 and a dot area of 100%. Therefore, the ratio of color densities is 1.21 (i.e. 87/72) and the ratio of dot area is 1.14 (i.e.; 100/88=1.14).

For a printed substrate having at least two solid print regions one of which is printed in accordance with the present invention, the ratio of color density between the two print regions is at least about 1.15, preferably at least about 1.20, and more preferably at least about 1.25. For a printed substrate having at least two solid print regions one of which is printed in accordance with the present invention, the dot area ratio between the two print regions is at least about 1.10, preferably about 1.20, and more preferably about 1.25.

Method 3: Method for Quantifying the Background Color Density Utilizing L*a*b Values

This method can be used to determine if background color density is greater than or the same as substrate color density. The method works for print regions comprised of discernible print elements.

Using a Nikon SMZ-U stereo microscope or equivalent, enlarge a local printed region by 34.4×. This is achieved with an ED Plan Apo 1× FL lens, a 2× setting on the zoom dial and an Optronics Engineering DEI-750 digital camera interface. All image adjustment settings on the camera are set to zero. The exposure is set to manual at 1/250. Two independent fiber optic light sources are oriented 75 degrees from the plane of the printed sample at a distance of 2 inches. A Fostec model Ace I light source is used at a setting of 3 and 70. Depending on the brightness of the substrate, the light source may be adjusted between 60 and 90 to minimize reflectance.

Metamorph v3.51 software is used to capture the image in a digital file. The software should is set to RGB mode with no flash. Brightness is set to 50, and all other settings (contrast, saturation, hue, and iris) are set to zero. The image is captured at 640×480 resolution.

Capture a printed region and an unprinted region of the substrate in the same image. If this is not possible, a separate image of each may be captured using the exact same setup (e.g., the same orientation of the light source, the same intensity of light, the same lens, etc.). The color densities of the unprinted substrates can be compared to insure that the setup or sample differences are not affecting the results.

In the case of a region printed with more than one color (for example, cyan and magenta), steps 2 and 4 below should be measured one color at a time. That is, when measuring magenta L*a*b values, the print element L*a*b values measured in step 2 should be in an area which is not printed with cyan. Likewise, the magenta background L*a*b values measured in step 4 should be in an area not printed with cyan.

1. Print the image using a Tektronix Phaser 450 printer onto Tektronix Phaser 450 printer paper. Color correction by the printer should be set to none. The final printed image should be enlarged 54× the original sample size.

2. Measure the L*a*b values of the print element in the center of a print element of a given color using a spectrocalorimeter such as an XRITE 938 Spectrodensitometer. Repeat this measurement for 8 different print elements and calculate the average L*a*b values for the 8. If the shape of the print element is irregular, the center should be approximated to be at the center of the largest circle which can be inscribed in the print element in an area of solid print (i.e.; contains no unprinted substrate). If two print elements are joined in any portion, the center of each print element should be approximated to be at the center of the largest circle which can be inscribed in the print element in an area of solid print. If there are irregularities in the printed regions due to substrate texture, the measurement should be taken only on print elements with printed areas larger than the aperture of the spectrocalorimeter.

3. Measure the substrate L*a*b values at 8 different unprinted regions of the substrate. Calculate the average substrate L*a*b values. The areas measured should be randomly chosen and on areas of the substrate which are representative of the printed substrate. For example, if the printed regions being measured in step 2 above have no embossments, the substrate L*a*b* values should also be measured in areas of no embossments.

4. Measure the background L*a*b values at a point equidistant from the centers of the nearest four print elements. In the case of biaxially staggered print elements, this will be in the center of and equidistant from four print elements. In the case of stoichastic print elements or other complex screening techniques, the point may not be precisely equidistant from the nearest points due to irregularities in the dot placement. However, every effort should be made to insure that it is as far as possible from the nearest print elements. Repeat this measurement at eight locations on the sample. The centers of the print elements can be approximated as described in step 2 if the shapes are irregular or touching other elements.

An article printed in accordance with the prior art should have background L*a*b values equivalent to the substrate L*a*b values. The value of ΔE is defined by the following equation:

ΔE=\sqrt{(L*₁−L*₀)²+(a*₁−a*₀)²+(b*₁−b*₀)²}

wherein L*₀, a*₀, and b*₀ refer to the L*a*b* value background and L*₁, a*₁, and b*₁ refer to the L*a*b* value of the substrate.

A printed substrate of the present invention may have a background ΔE of at least about 10, preferably at least about 20 and more preferably at least about 30.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A printed substrate having microscopic color density variation, said printed substrate comprising: a substrate having a first outer surface and a second outer surface opposed thereto, whereby at least one of said first or said second outer surface includes indicia, said indicia comprised of print elements and wherein said substrate includes a substrate color density, a background color density, and a print element color density wherein said background color density is greater than said substrate color density and less than said print element color density.

2. The printed substrate of claim 1 wherein said substrate is an absorbent disposable paper product.

3. The printed substrate of claim 1 further comprising a background ΔE of at least about 10.

4. The printed substrate of claim 1 wherein said substrate is textured.

5. A printed disposable paper product, said printed disposable paper product comprising: a substrate having a first outer surface and a second outer surface opposed thereto, whereby at least one of said first or said second outer surface includes ink applied thereto, said ink comprised of at least two solid print regions and wherein the color density ratio between the at least two solid print regions is at least about 1.15.

6. The printed disposable paper product of claim 5 wherein said two solid print regions have a dot area ratio of at least about 1.10

7. The printed disposable paper product of claim 5 wherein said substrate is textured.

8. A printed disposable paper product, said printed disposable paper product comprising:
a substrate having a first outer surface and a second outer surface opposed thereto, whereby at least one of said first or said second outer surface includes ink applied thereto, said ink comprised of at least two print regions said two print regions exhibiting the same color and the same color density and wherein the two print regions have a rub-off ratio greater than 1.1.

9. The printed disposable paper product of claim 8 wherein said substrate is textured.

10. The printed substrate of claim 1 wherein said substrate is cellulosic, noncellulosic, or a combination thereof.

11. The printed substrate of claim 1 wherein said indicia comprises a pigment based ink.

12. The printed substrate of claim 1 wherein said indicia comprises a process print.

13. The printed disposable paper product of claim 8 wherein said ink comprises a pigment.

14. The printed disposable paper product of claim 8 wherein said ink comprises a process print.

15. The printed disposable paper product of claim 5 wherein said at least two solid regions comprise line printing.
